(19) United States
(12) Patent Application Publication
(10) Pub. No.: US 2017/0066681 A1
(43) Pub. Date: Mar. 9, 2017

(54) GLASS PLATE FOR LIGHT GUIDE PLATE

(71) Applicant: Asahi Glass Company, Limited, Chiyoda-ku (JP)

(72) Inventors: Naoya WADA, Chiyoda-ku (JP); Yusuke ARAI, Chiyoda-ku (JP); Hiroyuki HIJIYA, Chiyoda-ku (JP)

(73) Assignee: Asahi Glass Company, Limited, Chiyoda-ku (JP)

(21) Appl. No.: 15/353,033

(22) Filed: Nov. 16, 2016

Related U.S. Application Data
(63) Continuation of application No. PCT/JP2015/063913, filed on May 14, 2015.

(30) Foreign Application Priority Data
Jun. 4, 2014 (JP) 2014-116095

(51) Int. Cl. C03C 3/085; C03C 3/095; F21V 8/00; C03C 3/093; C03C 3/087; C03C 3/11; C03C 3/091

(52) U.S. Cl. CPC C03C 3/085; C03C 3/11; C03C 3/095; C03C 3/091; C03C 3/093; C03C 3/087; G02B 6/0065

(57) ABSTRACT

A glass plate for a light guide plate includes a first glass layer; a second glass layer facing the first glass layer; and a third glass layer that is an intermediate glass layer formed between the first glass layer and the second glass layer, wherein the glass plate is provided with a three layer structure in a plate thickness direction, and wherein the glass plate satisfies t_{1C}/(t_{1B1}+t_{1B2}+t_{1C})<0.03 . . . (1); n_{1C}>n_{1B1} . . . (2); and n_{1C}>n_{1B2} . . . (3), where t_{1B1} is a thickness of the first glass layer, t_{1B2} is a thickness of the second glass layer, t_{1C} is a thickness of the third glass layer, n_{1B1} is a refractive index of the first glass layer, n_{1B2} is a refractive index of the second glass layer, and n_{1C} is a refractive index of the third glass layer.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2015/063913 filed on May 14, 2015 and designating the U.S., which claims priority of Japanese Patent Application No. 2014-116095 filed on Jun. 4, 2014. The entire contents of the foregoing applications are incorporated herein by reference.

### BACKGROUND OF THE INVENTION

1. Field of the Invention

The present disclosure relates to a glass plate for a light guide plate that is to be used for a liquid crystal display.

2. Description of the Related Art

A liquid crystal display includes a liquid crystal panel; a glass plate, as a light guide plate facing the liquid crystal panel; and a light source for irradiating light onto the liquid crustal panel through the glass plate (cf. Patent Document 1 (Japanese Unexamined Patent Publication No. 2004-252383, for example). Light from the light source enters an inner part from an edge surface of the glass plate; repeats surface reflection so as to spread over the whole inner part; and exits from a counter surface of the glass plate facing the liquid crystal panel, so that the liquid crystal panel is uniformly illuminated.

As a method of forming a glass plate, for example, a fusion method, or a float method is used. Additionally, after forming the glass plate, a chemically strengthening process may be applied.

For a case where a glass plate is formed by the fusion method, or for a case where a glass plate is formed by the float method and then the glass plate is chemically strengthened, the glass palte has a three layer structure in a plate thickness direction.

Furthermore, for a case where a glass plate is formed by the fusion method and then the glass plate is chemically strengthened, the glass plate has a five layer structure in the plate thickness direction.

Brightness of the light from the light guide plate with the three layer structure or the five layer structure has been low.

There is a need for a glass plate for a light guide plate such that the brightness of the light from the light guide plate is enhanced.

### SUMMARY OF THE INVENTION

According to an aspect of the present invention, there is provided a glass plate for a light guide plate including a first glass layer, a second glass layer facing the first glass layer, and a third glass layer, the third glass layer being an intermediate glass layer formed between the first glass layer and the second glass layer, wherein the glass plate is provided with a three layer structure in a plate thickness direction of the glass plate, wherein the glass plate satisfies

t_{1C}/(t_{1B1}+t_{1B2}+t_{1C})<0.03 (1);

n_{1C}>n_{1B1} (2); and

n_{1C}>n_{1B2} (3),

where t_{1B1} is a thickness of the first glass layer, t_{1B2} is a thickness of the second glass layer, t_{1C} is a thickness of the third glass layer, n_{1B1} is a refractive index of the first glass layer, n_{1B2} is a refractive index of the second glass layer, and n_{1C} is a refractive index of the third glass layer.

According to an embodiment of the present invention, a glass plate for a light guide plate can be provided such that brightness of light from the light guide plate is enhanced. Other objects, features and advantages of the present invention will become more apparent from the following detailed description when read in conjunction with the accompanying drawings.

### BRIEF DESCRIPTION OF THE DRAWINGS

FIG. 1 is a diagram illustrating a liquid crystal display according to an embodiment of the present invention;

FIG. 2 is a diagram illustrating an example of an optical spectrum of a white LED, which is formed of a blue LED and a yellow fluorophore;

FIG. 3 is a diagram illustrating an example of an optical spectrum of a white LED, which is formed of a blue LED, a green fluorophore, and a red fluorophore;

FIG. 4 is an illustration diagram of a fusion method, as a method of forming a glass plate for a light guide plate according to the embodiment of the present invention;

FIG. 5 is a diagram illustrating a structure of the glass plate for the light guide plate according to the embodiment of the present invention;

FIG. 6 is a diagram illustrating an example of a simulation analysis model;

FIG. 7 is a diagram illustrating an example of a transmission spectrum used for the simulation analysis.

FIG. 8 is a diagram illustrating, for a case where a thickness of a first glass layer is equal to a thickness of a second glass layer, an example of a relationship between a ratio of a thickness of a third glass layer with respect to a plate thickness of the glass plate and a brightness ratio of light from the glass plate;

FIG. 9 is a diagram illustrating, for a case where a refractive index of the first glass layer is equal to a refractive index of the second glass layer, an example of a relationship between a refractive index difference between the first layer and the third layer and the brightness ratio of the light from the glass plate;

FIG. 10 is a illustration diagram of a float method as a method of forming the glass plate according to a first modified example;

FIG. 11 is a diagram illustrating a structure of the glass plate according to the first modified example;

FIG. 12 is a diagram illustrating, for a case where the thickness of the first glass layer is equal to the thickness of the second glass layer, an example of a relationship between a ratio of the thickness of the first glass layer with respect to the plate thickness of the glass plate and the brightness ratio of light from the glass plate;

FIG. 13 is a diagram illustrating, for a case where the refractive index of the first glass layer is equal to the refractive index of the second glass layer, an example of a relationship between the refractive index difference between the first layer and the third layer and the brightness ratio of the light from the glass plate;

FIG. 14 is a diagram illustrating a structure of the glass plate according to a second modified example; and

FIG. 15 is a diagram illustrating, for a case where the thickness of the first glass layer is equal to a thickness of a fifth glass layer, and the thickness of the second glass layer is equal to a thickness of a fourth glass layer, an example of a relationship between a ratio of the thickness of the first glass layer with respect to the plate thickness of the glass plate and the brightness ratio of light from the glass plate.

### DESCRIPTION OF THE PREFERRED EMBODIMENTS

An embodiment for implementing the present invention is described below by referring to the accompanying drawings. In the drawings, the same or corresponding reference numerals are attached to the same or corresponding configurations, and thereby the descriptions are omitted. In the present specification, the expression “from x to y,” which represents a numerical range, is defined to be a range including the numerical values x and y, which are the lower limit and the upper limit, respectively.

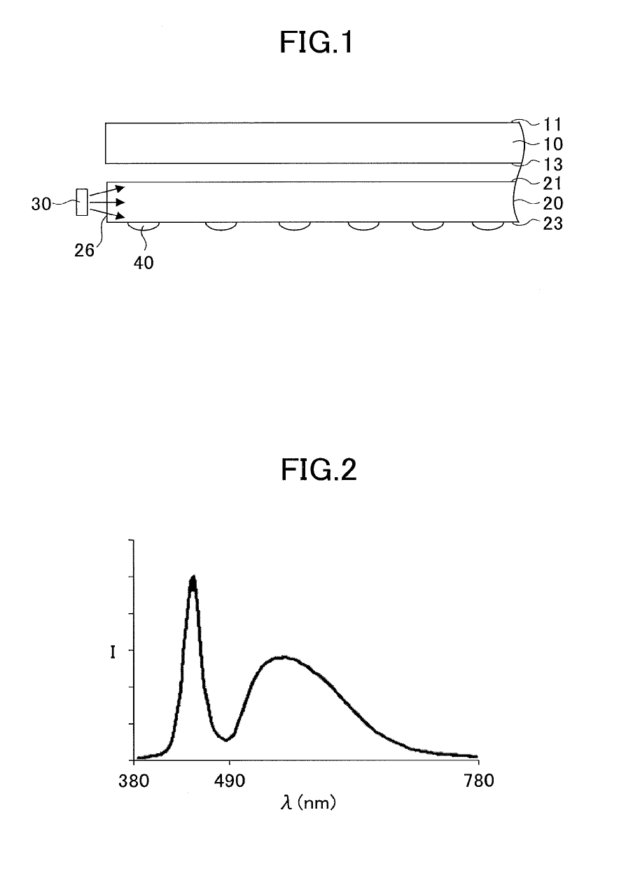

FIG. 1 is a diagram illustrating a liquid crystal display according to the embodiment of the present invention. The liquid crystal display includes a liquid crystal panel 10; a glass plate 20, as a light guide plate facing the liquid crystal panel 10; and a light source 30 that irradiates light onto the liquid crystal panel 10 through the glass plate 20. Note that the side of the liquid crystal panel 10 is the visible side of the liquid crystal display.

The liquid crystal panel 10 is formed of, for example, an array substrate; a color filter substrate; a liquid crystal layer; and so forth. The array substrate is formed of a substrate; active elements (e.g., thin film transistors (TFT)) that is formed on the substrate; and so forth. The color filter substrate is formed of a substrate; a color filter that is formed on the substrate; and so forth. The liquid crystal layer is formed between the array substrate and the color filter substrate.

The glass plate 20 faces the liquid crystal panel 10. The glass plate 20 is located at a side facing the visible side of the liquid crystal panel 10 (which is also referred to as the rear side). A surface 13 (rear surface) opposite to a display surface (front surface) 11 of the liquid crystal panel 10 and a front surface 21 of the glass plate 20 are arranged to be parallel.

On a rear surface 23 of the glass plate 20, a scattering structure is formed so as to extract light from the light guide plate. As the scattering structure, dots 40 or an irregular structure may be formed on the rear surface 23 of the glass plate 20; alternatively, a plurality of lenses may be formed on the rear surface 23 of the glass plate 20. Each of the dots 40 may include air bubbles or particles for scattering.

The rear surface 23 of the glass plate 20 is parallel to the front surface 21 of the glass plate 20.

The light source 30 irradiates light onto an edge surface 26 of the glass plate 20. The light from the light source 30 enters an inner part from the edge surface 26 of the glass plate 20; repeats surface reflection so as to spread over the entire inner part; and exits from the counter surface (the front surface) 21 of the glass plate 20 facing the liquid crystal panel 10, so that the liquid crystal panel 10 is uniformly illuminated from behind. Between the glass plate 20 and the liquid crystal panel 10, a scattering film, a brightness enhancement film, a reflection type polarizing film, a 3D film, a polarizing plate, and so forth may be located. Behind the glass plate 20, a reflection film may be located, for example. The light source 30, the glass plate 20, and the various types of optical films are collectively referred to as a backlight unit.

As the light source 30, a white LED is used, for example. The white LED may be formed of, for example, a blue LED; and a fluorophore that illuminates in response to receiving light from the blue LED. As the fluorophores, there are that of YAG-based; an oxide; aluminate; nitride; oxynitride; sulfide; oxysulfide; rare earth oxysulfide; halophosphate; chloride, and so forth.

For example, the white LED may be formed of the blue LED; and a yellow fluorophore. Alternatively, the white LED may be formed of the blue LED; a green fluorophore; and a red fluorophore. The light from the latter white LED is obtained by mixing the three primary colors of light, so that the light from the latter white LED is superior in a color rendering property.

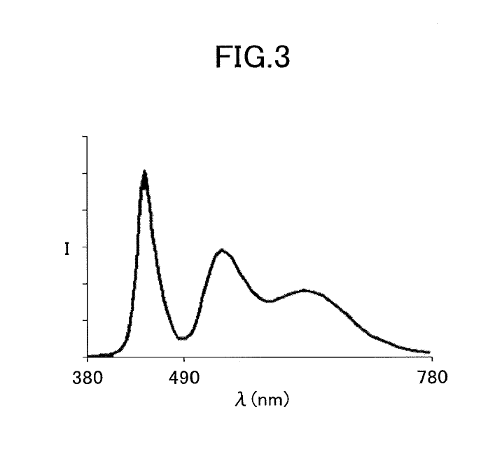

FIG. 2 is a diagram illustrating an example of an optical spectrum of the white LED that is formed of the blue LED and the yellow fluorophore. FIG. 3 is a diagram illustrating an example of an optical spectrum of the white LED that is formed of the blue LED, the green fluorophore, and the red fluorophore. In FIGS. 2 and 3, the horizontal axis indicates a wavelength (nm), and the vertical axis indicates intensity I.

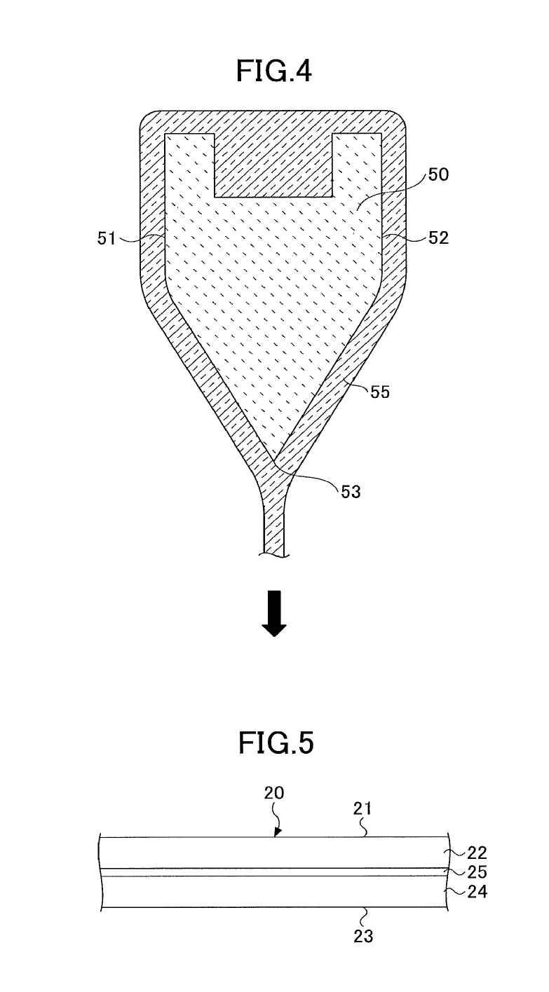

FIG. 4 is an illustration diagram of a float method, as a method of forming a glass plate for a light guide plate according to the embodiment of the present invention. FIG. 5 is a diagram illustrating a structure of the glass plate for the light guide plate according to the embodiment of the present invention.

As illustrated in FIG. 4, in the fusion method, melted glass 55 overflowing from a gutter-shaped member 50 toward left and right is caused to flow downward along left and right side surfaces 51 and 52 of the gutter-shaped member 50; the flows of the melted glass are caused to merge in the vicinity of a lower end 53 of the gutter-shaped member 50 where the left and right side surfaces 51 and 52 intersect; and the melted glass 55 is molded to have a band plate shape. A contact surface of the melted glass 55 contacting the gutter-shaped member 50 is to be a laminated surface of the melted glass 50. In the vicinity of the laminated surface, a component eluted from the gutter-shaped member 50 forms a foreign material layer.

As illustrated in FIG. 5, the glass plate 20 formed by the fusion method includes, between a front surface 21, as a light emitting surface, and a rear surface 23, as a light scattering surface, a first glass layer 22; an intermediate glass layer 25 (a third glass layer, which is the same hereinafter); and a second glass layer 24, in this order from the side of the front surface 21, so that the glass plate 20 has a three-layer structure in the plate thickness direction. The intermediate layer 25 is the foreign material layer, which is formed during molding by the fusion method; and the intermediate layer 25 is rich in the components eluted from the gutter-shaped member 50.

The glass plate 20 according to the embodiment satisfies the following formulas (1)-(3):

t_{1C}/(t_{1B1}+t_{1B2}+t_{1C})<0.03 (1)

b_{1C}>n_{1B1} (2)

n_{1C}>n_{1B2} (3)

Here, t_{1B1} is a thickness of the first glass layer 22; t_{1B2} is a thickness of the second glass layer 24; t_{1C} is a thickness of the intermediate glass layer 25; n_{1B1} is a refractive index of the first glass layer 22; n_{1B2} is a refractive index of the second glass layer 24; and n_{1C} is a refractive index of the intermediate glass layer 25. The refractive indexes are average values of refractive indexes of the respective layers. For comparing the refractive indexes of the respective layers, the refractive indexes may be represented by refractive indexes for the d-line of helium (the wavelength is 587.6 nm) at room temperature. The thickness of each layer is determined by any of the following methods: by using an optical microscope; by using a result of a composition analysis of, for example, zirconia by EPMA described below; or by using a refractive index calculated from a composition analysis by the EPMA described below. The most preferable method is to determine the thickness of each layer by using the refractive index calculated from the composition analysis by the EPMA; however, the thickness of each layer may be determined by using the optical microscope. The thickness of the glass plate 20 (i.e., t_{1B1}+t_{1B2}+t_{1C}) does not affect the brightness of the light guide plate; however, the thickness of the glass plate 20 is preferably greater than or equal to 0.2 mm, so that the stiffness of the glass plate 20 is sufficient. The thickness of the glass plate 20 is preferably less than 5 mm, so that the weight of the glass is moderate weight, and that the glass plate 20 is suitable for forming by the fusion method.

Flow rates of the melted glass 55 flowing down along both side surfaces of the gutter-shaped member 50 are approximately the same, so that the thickness t_{1B1} of the first glass layer 22 is approximately equal to the thickness t_{1B2} of the second glass layer 24. However, the thickness t_{1B1} of the first glass layer 22 may be different from the thickness t_{1B2} of the second glass layer 24.

Compositions of the melted glass 55 flowing down along both side surfaces of the gutter-shaped member 50 are approximately the same, so that the refractive index n_{1B1} of the first glass layer 22 is approximately equal to the refractive index n_{1B2} of the second glass layer 24.

The intermediate glass layer 25 is the foreign material layer, which is formed during molding; and the intermediate glass layer 25 is rich in the component of the gutter-shaped member 50. The gutter-shaped member 50 is formed of, for example, zirconia and so forth. The refractive index n_{1C} of the intermediate glass layer 25, which is rich in the zirconia component, is greater than the refractive index n_{1B1} of the first glass layer 22 and the refractive index n_{1B2} of the second glass layer 24 (n_{1C}>n_{1B1}, n_{1C}>n_{1B2}).

The refractive index n_{1C} of the intermediate glass layer 25 is obtained from the composition of the intermediate glass layer 25; more specifically, from a deviation of the composition of the intermediate glass layer 25 from a reference composition (mol %). The composition of the intermediate glass layer 25 is measured by an Electron Probe Micro Analyzer (EPMA). For each component, a product of the deviation from the reference composition and Appen's additivity factor (Source: A. A. Appen: Nisso Tsushinsha (1974) page 318) shown in Table 1 is obtained. The sum of these products is the difference between the refractive index of the intermediate glass layer 25 and the refractive index of the glass with the reference composition. As the reference composition, the composition of the first glass layer 22 or the composition of the second glass layer 24 may be used. Note that, for the composition of the intermediate glass layer 25, compositions may be measured at multiple points that are evenly spaced apart in the thickness direction of the intermediate glass layer 25, and the average of the measured compositions may be used as the composition of the intermediate glass layer 25. A deviation of the refractive index may be considered to be uniform over the entire wavelength spectrum of visible light.

TABLE 1

| Component | Additivity factor |
|---|---|
| SiO₂ | 1.47 |
| Al₂O₃ | 1.52 |
| MgO | 1.61 |
| CaO | 1.73 |
| SrO | 1.78 |
| BaO | 1.88 |
| Li₂O | 1.70 |
| Na₂O | 1.59 |
| K₂O | 1.58 |
| TiO₂ | 2.13 |
| ZrO₂ | 2.20 |
| ZnO | 1.71 |
| Ga₂O₃ | 1.77 |
| In₂O₃ | 2.34 |
| Sc₂O₃ | 2.24 |
| Y₂O₃ | 2.26 |
| La₂O₃ | 2.57 |
| Sb₂O₃ | 2.57 |
| Bi₂O₃ | 3.15 |
| GeO₂ | 1.64 |
| SnO₂ | 1.94 |
| P₂O₃ | 1.31 |
| Nb₂O₅ | 2.82 |

For a case where the glass plate 20 is formed by the fusion method, and the glass plate 20 has the three layer structure in the plate thickness direction, the brightness of the light from the glass plate 20 is enhanced if the above-described formulas (1) through (3) are satisfied, details of which are described below.

The brightness of the light from the glass plate 20 was obtained by simulation analysis. For the simulation analysis, optical ray tracing software (Light Tools: Produced by CYBERNET SYSTEMS CO., LTD.) was used.

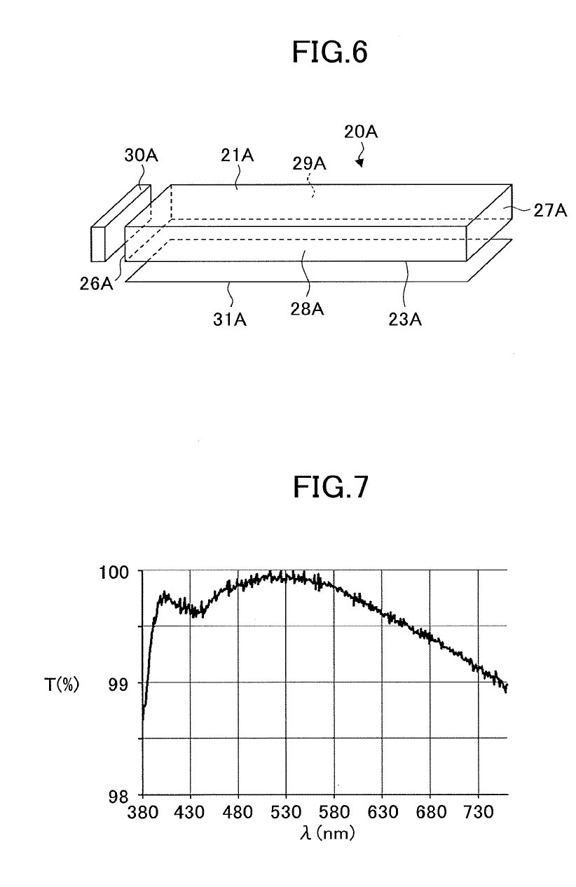

FIG. 6 is a diagram illustrating an example of a simulation analysis model. In this model, it was assumed that the glass plate 20A includes, similar to the glass plate 20 illustrated in FIG. 5, a three layer structure formed of the first glass layer 22, the second glass layer 24, and the intermediate glass layer 25. In this model, it was assumed that the size of the glass plate 20A is 10 mm×600 mm, and that the thickness of the glass plate 20 A is 2 mm; however, the tendency of the simulation result does not depend on the size and the thickness.

It was assumed that the thickness t_{1B1} of the first glass layer 22 is equal to the thickness t_{1B2} of the second glass layer 24 (t_{1B1}=t_{1B2}), and that the refractive index n_{1B1} of the first glass layer 22 is equal to the refractive index n_{1B2} of the second glass layer 24 (n_{1B1}=n_{1B2}). For the simulation analysis, the refractive index discontinuously varies on the boundary surface between the first glass layer 22 and the intermediate glass layer 25, and on the boundary surface between the second glass layer 24 and the intermediate glass layer 25 so as to simplify the model. However, since the actual refractive index continuously varies, it was assumed that Fresnel reflection does not occur on these surfaces.

A surface light source 30A, which was parallel to an edge surface 26A, was provided at a position separated, by 1 mm, from the edge surface 26A, which was one of mutually parallel edge surfaces 26A and 27A (the size was 2 mm×10 mm, and the distance was 600 mm) of the glass plate 20A. Note that, for a case where a plurality of point light sources are arranged, instead of adopting the surface light source as the light source, the tendency of the result does not change.

As the optical spectrum of the surface light source 30A, the optical spectrum of the white LED was used, which was formed of the blue LED, the red fluorophore, and the green fluorophore. It was assumed that the number of rays entering the edge surface 26A of the glass plate 20A from the surface light source 30A was 250,000. Note that, even if an optical spectrum of a different type of light source is used, the tendency of the result does not change.

Transmittance of the glass plate 20 was calculated based on internal transmittance (the transmission distance was 10 mm) (cf. FIG. 7), which was obtained from an actual measurement value, and a traveling distance of each ray. FIG. 7 is a diagram illustrating an example of a transmission spectrum (the transmission distance was 10 mm) that was used for simulation analysis. In FIG. 7, the horizontal axis represents a wavelength λ (nm), and the vertical axis represents internal transmittance T (%).

The reflectance of light on the edge surface 27A, and left and right side surfaces 28A and 29A of the surfaces of the glass plate 20A was assumed to be 98%, as it was assumed that a reflective tape with reflectance of 98% was pasted on these surfaces. Then, convex lenses were arranged on the rear surface 23A in a hexagonal lattice shape, so that the light was uniformly extracted from the front surface 21A; and the sizes of the convex lenses were set such that, as the distance from the surface light source 30A became greater, the size of the convex lens became greater. Additionally, a light reflecting surface 31A (reflectance 98%), which was parallel to the rear surface 23A, was provided at a position separated from the rear surface 23A by 0.1 mm. The light reflecting surface 31A reflects the light transmitted through the rear surface 23A toward the rear surface 23A. Note that the light reflecting surface 31A corresponds to a reflection sheet in the backlight unit.

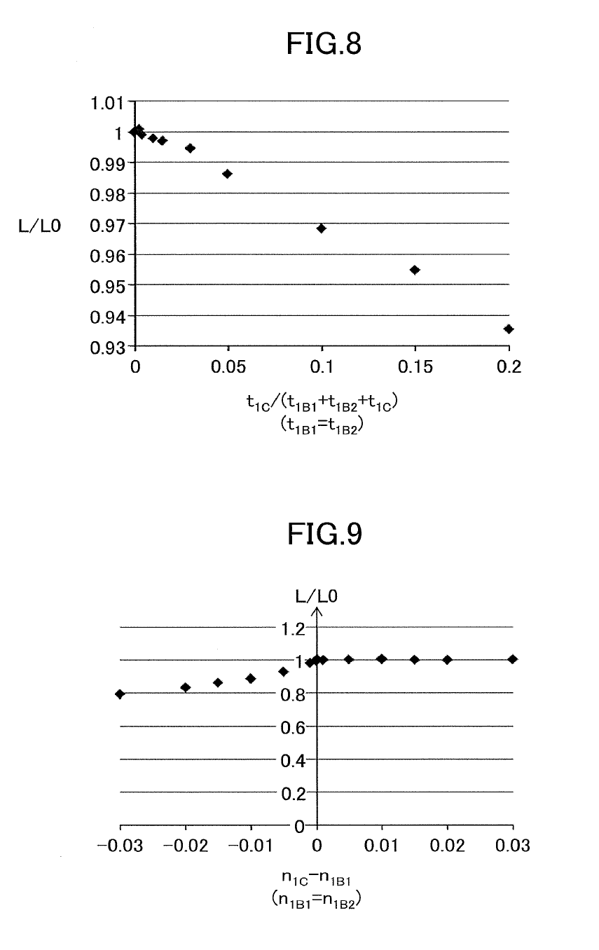

Table 2 and FIG. 8 show an example of a relationship between a brightness ratio L/L0 of the light from the glass plate 20 and a ratio of the thickness of the intermediate glass layer 25 with respect to the plate thickness of the glass plate 20A (t_{1C}/(t_{1B1}+t_{1B2}+t_{1C})). The brightness L of the light from the glass plate 20A is average brightness of the rays with respective wavelengths extracted from the front surface 21A. The brightness ratio L/L0 is a normalized value obtained by setting the brightness L0 to be 1 for a case where the refractive indexes are the same for the first glass layer 22, the second glass layer 24, and the intermediate glass layer 25 (n_{1B1}=n_{1B2}=n_{1C}). It was assumed that the first glass layer 22 and the second glass layer 24 had the same refractive indexes and the same thicknesses. The refractive index n_{1B1} of the first glass layer 22 was set to be 1.520 for all wavelengths of the visible light. The refractive index n_{1C} of the intermediate glass layer 25 was set to be a value that was greater than the refractive index n_{1B1} of the first glass layer 22 by 0.015 (n_{1C1}−n_{1B1}=0.015) for all wavelengths of the visible light. Note that, even if the variance of the refractive index is considered, the tendency of the result does not change.

TABLE 2

| n_{1C} − n_{1B1} | 0.0150 | 0.0150 | 0.0150 | 0.0150 | 0.0150 |
|---|---|---|---|---|---|
| t_{1C}/(t_{1B1} + t_{1B2} + t_{1C}) | 0.0000 | 0.0025 | 0.0040 | 0.0100 | 0.0150 |
| L(Ix) | 30664.6 | 30693.9 | 30637.9 | 30601.3 | 30575.6 |
| L/L0 | 1.00000 | 1.00095 | 0.99913 | 0.99794 | 0.99710 |
| n_{1C} − n_{1B1} | 0.0150 | 0.0150 | 0.0150 | 0.0150 | 0.0150 |
| t_{1C}/(t_{1B1} + t_{1B2} + t_{1C}) | 0.0300 | 0.0500 | 0.1000 | 0.1500 | 0.2000 |
| L(Ix) | 30501.7 | 30243.0 | 29697.0 | 29281.7 | 28687.2 |
| L/L0 | 0.99469 | 0.98625 | 0.96844 | 0.95490 | 0.93551 |

From Table 2 and FIG. 8, it can be seen that, if the ratio of the thickness of the intermediate glass layer 25 with respect to the plate thickness of the glass plate 20A (t_{1C}/(t_{1B1}+t_{1B2}+t_{1C})) is less than 0.03, the brightness almost does not decrease despite the presence of the three layer structure. The ratio of the thickness of the intermediate glass layer 25 with respect to the plate thickness of the glass plate 20A (t_{1C}/(t_{1B1}+t_{1B2}+t_{1C})) is preferably less than 0.02, and more preferably less than 0.01.

The ratio of the thickness of the intermediate glass layer 25 with respect to the plate thickness of the glass plate 20A (t_{1C}/(t_{1B1}+t_{1B2}+t_{1C})) can be adjusted by adjusting a flow rate and temperature of the melted glass 55 flowing down along both side surfaces of the gutter-shaped member 50. As the flow rate becomes greater, elution from the gutter-shaped member 50 becomes smaller, so that the ratio of the thickness of the intermediate glass layer 25 decreases. Additionally, as the temperature becomes lower, elution from the gutter-shaped member 50 becomes smaller, so that the ratio of the thickness of the intermediate glass layer 25 decreases.

Table 3 and FIG. 9 show an example of the relationship between the brightness ratio L/L0 of the light from the glass plate 20A and a refractive index difference (n_{1C}−n_{1B1}) between the intermediate glass layer 25 and the first glass layer 22. Here, it was assumed that the first glass layer 22 and the second glass layer 24 had the same refractive indexes and the same thicknesses. Furthermore, the refractive index n_{1B1} of the first glass layer 22 was set to be 1.520 for all wavelengths of the visible light. The difference between the refractive index n_{1B1} of the first glass layer 22 and the refractive index n_{1C} of the intermediate glass layer 25 (n_{1C}−n_{1B1}) was set to be the values shown in Table 3 for all wavelengths of the visible light. The ratio of the thickness of the intermediate glass layer 25 with respect to the plate thickness of the glass plate 20A (t_{1C}/(t_{1B1}+t_{1B2}+t_{1C})) was set to be 0.0025 (constant).

TABLE 3

| | | | | | | | | |
|---|---|---|---|---|---|---|---|---|
| n_{1C} − n_{1B1} | −0.0300 | −0.0200 | −0.0150 | −0.0100 | −0.0050 | −0.0010 | −0.0001 | 0.0000 |
| t_{1C}/ | 0.0025 | 0.0025 | 0.0025 | 0.0025 | 0.0025 | 0.0025 | 0.0025 | 0.0025 |
| (t_{1B1} + t_{1B2} + t_{1C}) | | | | | | | | |
| L(Ix) | 24328.6 | 25537.5 | 26451.1 | 27204.9 | 28476.7 | 30092.9 | 30450.2 | 30664.6 |
| L/L0 | 0.79338 | 0.83280 | 0.86259 | 0.88718 | 0.92865 | 0.98135 | 0.99301 | 1.00000 |

| | | | | | | | |
|---|---|---|---|---|---|---|---|
| n_{1C} − n_{1B1} | 0.0001 | 0.0010 | 0.0050 | 0.0100 | 0.0150 | 0.0200 | 0.0300 |
| t_{1C}/ | 0.0025 | 0.0025 | 0.0025 | 0.0025 | 0.0025 | 0.0025 | 0.0025 |
| (t_{1B1} + t_{1B2} + t_{1C}) | | | | | | | |
| L(Ix) | 30791.7 | 30624.7 | 30753.5 | 30850.9 | 30693.9 | 30680.8 | 30763.4 |
| L/L0 | 1.00415 | 0.99870 | 1.00290 | 1.00608 | 1.00095 | 1.00053 | 1.00322 |

From Table 3 and FIG. 9, it can be seen that, if the refraction index n_{1C} is greater than the refraction index n_{1B1} of the first glass layer 22 and the refraction index n_{1B2} of the second glass layer 24, the brightness almost does not decrease despite the presence of the three layer structure.

The refractive index n_{1C} of the intermediate glass layer 25 can be adjusted, for example, by adjusting the material of the gutter-shaped member 50. When the gutter-shaped member 50 is formed of zirconia, the intermediate glass layer 25 is richer in the zirconia component compared to the first glass layer 22 and the second glass layer 24, so that the intermediate glass layer 25 has the refractive index that is greater than refractive indexes of the first glass layer 22 and the second glass layer 24.

Note that the brightness of the light from the glass plate 20A can be enhanced by forming a cross-sectional shape of the boundary surface between the first glass layer 22 and the intermediate glass layer 25 to be a wavy surface; and by forming a cross-sectional shape of the boundary surface between the second glass layer 24 and the intermediate glass layer 25 to be a wavy surface. For a case where these boundary surfaces are parallel surfaces, light that enters these boundary surfaces with an incident angle that is greater than or equal to the total reflection angle is confined in the intermediate glass layer 25. However, if the cross-sectional shapes of these boundary surfaces are wavy surfaces, the light can pass through the boundary surfaces after repeating reflection on these boundary surfaces, so that confinement of the light can be suppressed. Here, a period and amplitude of the wave may or may not be constant. As a method of forming the cross-sectional shape of the boundary surface to be a wavy shape, for example, there are a method based on varying a temperature difference between the melted glass flowing down along both side surfaces of the gutter-shaped member 50, a method based on fluctuating the gutter-shaped member 50, and so forth. In the first modified example below, in order to avoid confinement of light, the cross-sectional shape of the boundary surface may be formed to be a wavelike shape. Here, as a method of foaming, in the first modified example described below, the cross-sectional shape of the boundary surface to be a wavy surface, for example, a method can be considered such that crystals containing calcium are caused to be partially precipitated by contacting the glass with moisture, and then the glass is chemically strengthened. The same applies to the second modified example described below.

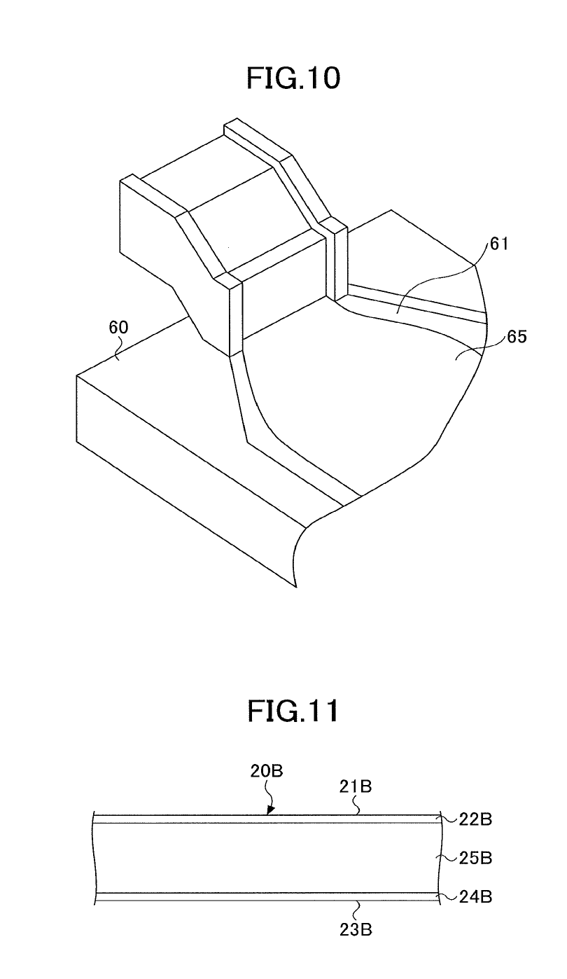

FIG. 10 is a illustration diagram of the float method, as a method of forming the glass plate according to the first modified example. FIG. 11 is a diagram illustrating a structure of the glass plate according to the first modified example.

As illustrated in FIG. 10, in the float method, a melted glass 65 that is continuously supplied onto a melted metal (e.g., melted tin) 61 in a tub 60 is caused to flow on the melted metal 61, so that the melted glass 65 is shaped to have a band plate shape. After shaping, the glass plate 20B is obtained by applying a chemically strengthening process. Chemical strengthening is for forming a compressive stress layer by ion-exchanging ions having small ion radiuses (e.g., Na ions) on the glass surface with ions having large ion radiuses (e.g., K ions).

As illustrated in FIG. 11, the glass plate 20B, which is formed by the float method and then chemically strengthened, is provided with, between a front surface 21B as the light emitting surface and a rear surface 23B as the light scattering surface, a first glass layer 22B; an intermediate glass layer (third glass layer, which is the same hereinafter) 25B; and a second glass layer 24B, in this order from the side of the front surface 21B, so that the glass plate 20B has a three layer structure in the plate thickness direction. The first glass layer 22B and the second glass layer 24B are compressive stress layers formed by ion-exchange. The intermediate glass layer 25B is a tensile stress layer formed by the reaction of the formation of the compressive stress layer.

The glass plate 20B according to the modified example satisfies the following formulas (4)-(7):

t_{2E1}/(t_{2E1}+t_{2E2}+t_{2B})<0.08 (4)

t_{2E2}/(t_{2E1}+t_{2E2}+t_{2B})<0.08 (5)

n_{2B}<n_{2E1} (6)

n_{2B}<n_{2E2} (7)

Here, t_{2E1} is a thickness of the first glass layer 22B; t_{2E2} is a thickness of the second glass layer 24B; t_{2B} is a thickness of the intermediate glass layer 25B; n_{2E1} is a refractive index of the first glass layer 22B; n_{2E2} is a refractive index of the second glass layer 24B; and n_{2B} is a refractive index of the intermediate glass layer 25B. The refractive indexes are average values of refractive indexes of the respective layers. For comparing the refractive indexes of the respective layers, the refractive indexes may be represented by refractive indexes for the d-line of helium (the wavelength is 587.6 nm) at room temperature. The thickness of each layer can be measured by a surface stress measuring device, such as the surface stress measuring meter FSM-6000 produced by Orihara industrial co., ltd. The thickness of the glass plate 20B (i.e., t_{2E1}+t_{2E2}+t_{2B}) does not affect the brightness of the light guide plate; however, the thickness of the glass plate 20B is preferably greater than or equal to 0.2 mm, so that the stiffness of the glass plate 20B is sufficient. The thickness of the glass plate 20B is preferably less than 5 mm, so that the weight of the glass is moderate weight.

For a case where the conditions on the chemical strengthening (e.g., processing temperature, processing time, and processing liquid) are the same for the first glass layer 22B and the second glass layer 24B, the thickness t_{2E1} of the first glass layer 22B is substantially equal to the thickness t_{2E2} of the second glass layer 24B. Here, the thickness t_{2E1} of the first glass layer 22B may be different from the thickness t_{2E2} of the second glass layer 24B.

For the case where the conditions on the chemical strengthening (e.g., processing temperature, processing time, and processing liquid) are the same for the first glass layer 22B and the second glass layer 24B, the refractive index n_{2E1} of the first glass layer 22B is substantially equal to the refractive index n_{2E2} of the second glass layer 24B. Here, the refractive index n_{2E1} of the first glass layer 22B may be different from the refractive index n_{2E2} of the second glass layer 24B.

In the first glass layer 22B and the second glass layer 24B, the K component increases and the Na component decreases, compared to the intermediate glass layer 25B. Consequently, the refractive index n_{2E1} of the first glass layer 22B and the refractive index n_{2E2} of the second glass layer 24B are greater than the refractive index n_{2B} of the intermediate glass layer 25B (n_{2B}<n_{2E1}, n_{2B}<n_{2E2}).

The refractive index n_{2E1} of the first glass layer 22B is obtained from a deviation from the refractive index n_{2B} of the intermediate glass layer 25B. The deviation of the refractive index can be obtained by observing, by a transmission-type two-beam interference microscope, how much the interference fringes generated in the first glass layer 22B are deviated from the interference fringes generated in the intermediate glass layer 25B. Specifically, if it is assumed that the interference fringes are deviated by N lines, respectively, the deviation of the refractive index is N×λ/t. Here, λ is the wavelength of the light used for the observation, and t is the thickness of the sample used for the observation. Note that, for the deviation of the refractive index n_{2E1} of the first glass layer 22B from the refractive index n_{2B} of the intermediate glass layer 25B, deviations may be measured at multiple points in the first glass layer 22B that are evenly spaced apart in the thickness direction of the first glass layer 22B, and the average of these deviations may be used as the deviation. A deviation of the refractive index may be considered to be uniform over the entire wavelength spectrum of visible light.

For a case where the glass plate 20B is formed by the float method and then chemically strengthened, and the glass plate 20B has the three layer structure in the plate thickness direction, the brightness of the light from the glass plate 20B is enhanced if the above-described formulas (4) through (7) are satisfied, details of which are described below.

The brightness of the light from the glass plate 20B was obtained by simulation analysis. For the simulation analysis, optical ray tracing software (Light Tools: Produced by CYBERNET SYSTEMS CO., LTD.) was used. As the simulation analysis model, the model illustrated in FIG. 6 was used. In this model, it was assumed that the glass plate 20A includes, similar to the glass plate 20B illustrated in FIG. 11, a three layer structure formed of the first glass layer 22B, the second glass layer 24B, and the intermediate glass layer 25B. In this model, it was assumed that the size of the glass plate 20A is 10 mm×600 mm, and that the thickness of the glass plate 20 A is 2 mm; however, the tendency of the simulation result does not depend on the size and the thickness. As the optical spectrum of the surface light source 30A, the optical spectrum of the white LED was used, which was formed of the blue LED, the red fluorophore, and the green fluorophore; however, if an optical spectrum of a different type of light source is used, the tendency of the result does not change. Furthermore, for a case where a plurality of point light sources are arranged, instead of adopting the surface light source as the light source, the tendency of the result does not change.

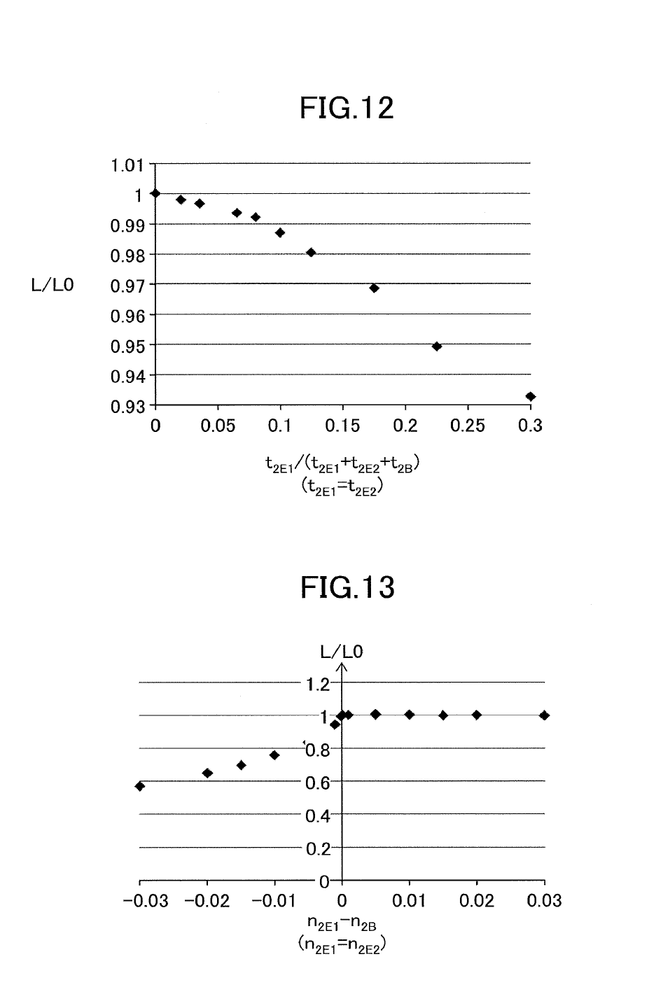

Table 4 and FIG. 12 show an example of a relationship between a brightness ratio of the light from the glass plate 20A and a ratio of the thickness of the first glass layer 22B with respect to the plate thickness of the glass plate 20A (t_{2E1}/(t_{2E1}+t_{2E2}+t_{2B})). It was assumed that the first glass layer 22B and the second glass layer 24B had the same refractive indexes and the same thicknesses. The refractive index n_{2B} of the intermediate glass layer 25B was set to be 1.520 for all wavelengths of the visible light. The refractive index n_{2E1} of the first glass layer 22B was set to be a value that was greater than the refractive index n_{2B} of the intermediate glass layer 25B by 0.015 (n_{2E1}−n_{2B}=0.015) for all wavelengths of the visible light. Note that, even if the variance of the refractive index is considered, the tendency of the result does not change.

TABLE 4

| n_{2E1} − n_{2B} | 0.0150 | 0.0150 | 0.0150 | 0.0150 | 0.0150 |
|---|---|---|---|---|---|
| t_{2E1}/(t_{2E1} + t_{2E2} + t_{2B}) | 0.0000 | 0.0200 | 0.0350 | 0.0650 | 0.0800 |
| L(Ix) | 30664.6 | 30598.6 | 30560.5 | 30465.8 | 30420.8 |
| L/L0 | 1.00000 | 0.99785 | 0.99661 | 0.99352 | 0.99205 |
| n_{2E1} − n_{2B} | 0.0150 | 0.0150 | 0.0150 | 0.0150 | 0.0150 |
| t_{2E1}/(t_{2E1} + t_{2E2} + t_{2B}) | 0.1000 | 0.1250 | 0.1750 | 0.2250 | 0.3000 |
| L(Ix) | 30264.9 | 30064.8 | 29703.3 | 29110.4 | 28601.4 |
| L/L0 | 0.98697 | 0.98044 | 0.96865 | 0.94931 | 0.93272 |

From Table 4 and FIG. 12, it can be seen that, if the ratio of the thickness of the first glass layer 22B with respect to the plate thickness of the glass plate 20B (t_{2E1}/(t_{2E1}+t_{2E2}+t_{2B})) is less than 0.08, the brightness almost does not decrease despite the presence of the three layer structure. The ratio of the thickness of the first glass layer 22B with respect to the plate thickness of the glass plate 20B (t_{2E1}/(t_{2E1}+t_{2E2}+t_{2B})) is preferably less than 0.06, and more preferably less than 0.04. The same applies to the ratio of the thickness of the second glass plate 24B with respect to the plate thickness of the glass plate 20B (t_{2E2}/(t_{2E1}+t_{2E2}+t_{2B})).

The ratio of the thickness of the first glass layer 22B with respect to the plate thickness of the glass plate 20B (t_{2E1}/(t_{2E1}+t_{2E2}+t_{2B})) can be adjusted by adjusting conditions on chemical strengthening (e.g., processing temperature, processing time, and processing liquid). As the processing temperature becomes lower, the ion exchange reaction becomes slower, so that the ratio of the thickness of the first glass layer 22B decreases. Furthermore, as the processing time becomes shorter, the thickness of the first glass layer 22B decreases. The same applies to the ratio of the thickness of the second glass plate 24B with respect to the plate thickness of the glass plate 20B (t_{2E2}/(t_{2E1}+t_{2E2}+t_{2B})).

Table 5 and FIG. 13 show an example of a relationship between a brightness ratio of the light from the glass plate 20B and the refractive index difference (n_{2E1}−n_{2E2}) between the first glass layer 22B and the intermediate glass layer 25B. The refractive index n_{2B} of the intermediate glass layer 25B was set to be 1.520 for all wavelengths of the visible light. It was assumed that the refractive index n_{2E1} of the first glass layer 22B and the refractive index n_{2E2} of the second glass layer 24B are the same (n_{2E1}=n_{2E2}), and that the difference between the refractive index n_{2E1} of the first glass layer 22B and the refractive index n_{2B} of the intermediate glass layer 25B (n_{2E1}−n_{2B}) was set to be the values shown in Table 5. The ratio of the thickness of the first glass layer 22B with respect to the plate thickness of the glass plate 20B (t_{2E1}/(t_{2E1}+t_{2E2}+t_{2B})) was set to be 0.02 (constant). Note that, even if the variance of the refractive index is considered, the tendency of the result does not change.

TABLE 5

| | | | | | | | | |
|---|---|---|---|---|---|---|---|---|
| n_{2E1} − n_{2B} | 0.0300 | 0.0200 | 0.0150 | 0.0100 | 0.0050 | 0.0010 | 0.0001 | 0.0000 |
| t_{2E1}/ | 0.0200 | 0.0200 | 0.0200 | 0.0200 | 0.0200 | 0.0200 | 0.0200 | 0.0200 |
| (t_{2E1} + t_{2E2} + t_{2B}) | | | | | | | | |
| L(Ix) | 30577.2 | 30688.4 | 30598.6 | 30773.0 | 30832.9 | 30701.9 | 30740.4 | 30664.6 |
| L/L0 | 0.99715 | 1.00078 | 0.99785 | 1.00353 | 1.00549 | 1.00122 | 1.00247 | 1.00000 |

| | | | | | | | |
|---|---|---|---|---|---|---|---|
| n_{2E1} − n_{2B} | −0.0001 | −0.0010 | −0.0050 | −0.0100 | −0.0150 | −0.0200 | −0.0300 |
| t_{2E1}/ | 0.0200 | 0.0200 | 0.0200 | 0.0200 | 0.0200 | 0.0200 | 0.0200 |
| (t_{2E1} + t_{2E2} + t_{2B}) | | | | | | | |
| L(Ix) | 30424.3 | 28910.5 | 25648.1 | 23246.4 | 21350.5 | 19918.0 | 17517.8 |
| L/L0 | 0.99216 | 0.94280 | 0.83641 | 0.75809 | 0.69626 | 0.64954 | 0.57127 |

From Table 5 and FIG. 13, it can be seen that, if the refraction index n_{2B} is less than the refraction index n_{2E1} of the first glass layer 22B and the refraction index n_{2E2} of the second glass layer 24B, the brightness almost does not decrease despite the presence of the three layer structure.

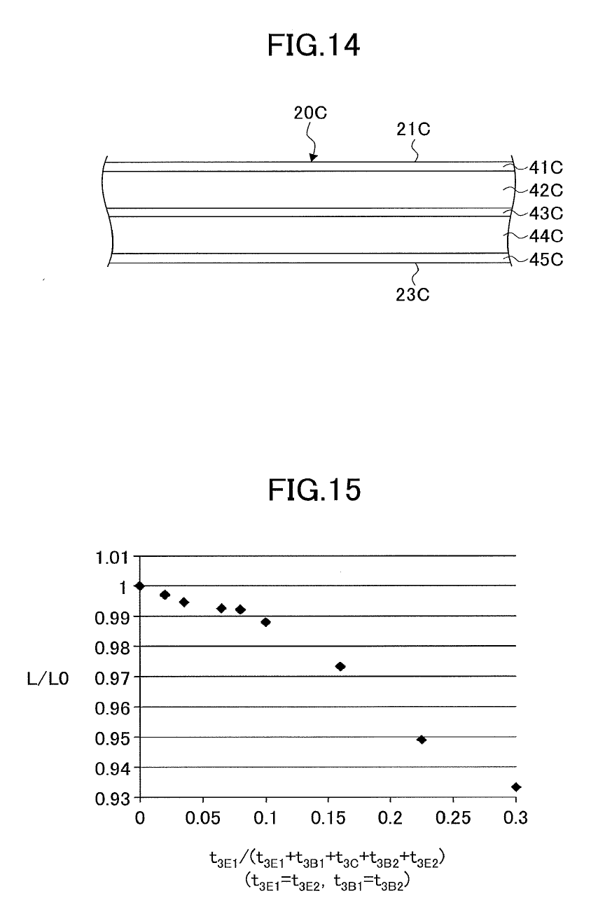

FIG. 14 is a diagram illustrating a structure of the glass plate according to the second modified example. The glass plate 20C illustrated in FIG. 14 is formed by the fusion method, and then chemically strengthened. The glass plate 20C includes, between a front surface 21C as the light emitting surface and a rear surface 23C as the light scattering surface, a first glass layer 41C; a second glass layer 42C; a third glass layer 43C, a fourth glass layer 44C; and a fifth glass layer 45C, in this order from the side of the front surface 21C.

The first glass layer 41C and the fifth glass layer 45C are compressive stress layers, respectively, formed by the ion-exchanging. The second glass layer 42C, the third glass layer 43C, and the fourth glass layer 44C are tensile stress layers, respectively, formed by the reaction of the formation of the compressive stress layers. The third glass layer 43C is a foreign material layer formed during formation by the fusion method, and the third glass layer 43C is rich in the component eluted from the gutter-shaped member 50.

The glass plate 20C according to the modified example satisfies the following formulas (8)-(16):

t_{3C}/(t_{3E1}+t_{3B1}+t_{3C}+t_{3B2}+t_{3E2})<0.03 (8)

t_{3E1}/(t_{3E1}+t_{3B1}+t_{3C}+t_{3B2}+t_{3E2})<0.08 (9)

t_{3E2}/(t_{3E1}+t_{3B1}+t_{3C}+t_{3B2}+t_{3E2})<0.08 (10)

n_{3C}>n_{3B1} (11)

n_{3C}>n_{3B2} (12)

n_{3E1}>n_{3B1} (13)

n_{3E1}>n_{3B2} (14)

n_{3E2}>n_{3B1} (15)

n_{3E2}>n_{3B2} (16)

Here, t_{3E1} is a thickness of the first glass layer 41C; t_{3B1} is a thickness of the second glass layer 42C; t_{3C} is a thickness of the third glass layer 43C; t_{3B2} is a thickness of the fourth glass layer 44C; t_{3E2} is a thickness of the fifth glass layer 45C; n_{3E1} is a refractive index of the first glass layer 41C; n_{3B1} is a refractive index of the second glass layer 42C; n_{3C} is a refractive index of the third glass layer 43C; n_{3E2} is a refractive index of the fourth glass layer 44C; and n_{3E2} is a refractive index of the fifth glass layer 45C. The refractive indexes are average values of refractive indexes of the respective layers. For comparing the refractive indexes of the respective layers, the refractive indexes may be represented by refractive indexes for the d-line of helium (the wavelength is 587.6 nm) at room temperature. The method of measuring each layer is as described above. The thickness of the glass plate 20C (i.e., t_{3E1}+t₃₃₁+t_{3C}+t₃₃₂+t_{3E2}) does not affect the brightness of the light guide plate; however, the thickness of the glass plate 20C is preferably greater than or equal to 0.2 mm, so that the stiffness of the glass plate 20C is sufficient. The thickness of the glass plate 20C is preferably less than 5 mm, so that the weight of the glass is moderate weight, and that the glass plate 20C is suitable for forming by the fusion method.

For a case where the conditions on the chemical strengthening (e.g., processing temperature, processing time, and processing liquid) are the same for the first glass layer 41C and the fifth glass layer 45C, the thickness t_{3E1} of the first glass layer 41C is substantially equal to the thickness t_{3E2} of the fifth glass layer 45C. Here, the thickness t_{3E1} of the first glass layer 41C may be different from the thickness t_{3E2} of the fifth glass layer 45C.

In the first glass layer 41C and the fifth glass layer 45C, the K component increases and the Na component decreases, compared to the second glass layer 42C and the fourth glass layer 44C. Consequently, the refractive index n_{3E1} of the first glass layer 41C is greater than the refractive index n_{3E1} of the second glass layer 42C and the refractive index n_{3B2} of the fourth glass layer 44C.

Similarly, the refractive index n_{3E2} of the fifth glass layer 45C is greater than the refractive index n_{3B1} of the second glass layer 42C and the refractive index n_{3B2} of the fourth glass layer 44C.

For a case where flow rates of the melted glass flowing down along both side surfaces of the gutter-shaped member 50 are approximately the same, the thickness t_{3B1} of the second glass layer 42C is approximately equal to the thickness t_{3B2} of the fourth glass layer 44C. However, the thickness t_{3B1} of the second glass layer 42C may be different from the thickness t_{3B2} of the fourth glass layer 44C.

Compositions of the melted glass 55 flowing down along both side surfaces of the gutter-shaped member 50 are approximately the same, so that the refractive index n_{3B1} of the second glass layer 42C is approximately equal to the refractive index n_{3B2} of the fourth glass layer 44C.

The third glass layer 43C is the foreign material layer, which is formed during molding; and the third glass layer 43C is rich in the component of the gutter-shaped member 50. The gutter-shaped member 50 is formed of, for example, zirconia and so forth. The refractive index n_{3C} of the third glass layer 43C, which is rich in the zirconia component, is greater than the refractive index n_{3B1} of the second glass layer 42C and the refractive index n_{3B2} of the fourth glass layer 44C (n_{3C}>n_{3B1}, n_{3C}>n_{3B2}).

For a case where the glass plate 20C is formed by the fusion method and then chemically strengthened, and the glass plate 20C has the five layer structure in the plate thickness direction, the brightness of the light from the glass plate 20C is enhanced if the above-described formulas (8) through (16) are satisfied, details of which are described below.

The brightness of the light from the glass plate 20C was obtained by simulation analysis. For the simulation analysis, optical ray tracing software (Light Tools: Produced by CYBERNET SYSTEMS CO., LTD.) was used. As the simulation analysis model, the model illustrated in FIG. 6 was used. In this model, it was assumed that the glass plate 20A includes, similar to the glass plate 20C illustrated in FIG. 14, a five layer structure formed of the first glass layer 41C, the second glass layer 42C, the third glass layer 43C, the fourth glass layer 44C, and the fifth glass layer 45C. In this model, it was assumed that the size of the glass plate 20A is 10 mm×600 mm, and that the thickness of the glass plate 20 A is 2 mm; however, the tendency of the simulation result does not depend on the size and the thickness. As the optical spectrum of the surface light source 30A, the optical spectrum of the white LED was used, which was formed of the blue LED, the red fluorophore, and the green fluorophore; however, if an optical spectrum of a different type of light source is used, the tendency of the result does not change. Furthermore, for a case where a plurality of point light sources are arranged, instead of adopting the surface light source as the light source, the tendency of the result does not change.

Table 6 and FIG. 15 show an example of a relationship between a brightness ratio of the light from the glass plate 20A and a ratio of the thickness of the first glass layer 41C with respect to the plate thickness of the glass plate 20C (t_{3E1}/(t_{3E1}+t_{3B1}+t_{3C}+t_{3B2}+t_{3E2})). It was assumed that the first glass layer 41C and the fifth glass layer 45C had the same refractive indexes and the same thicknesses; and that the second glass layer 41C and the fourth glass layer 44C had the same refractive indexes and the same thicknesses. The refractive index n_{3B1} of the second glass layer 42C was set to be 1.520 for all wavelengths of the visible light. The refractive index n_{3E1} of the first glass layer 41C was set to be a value that was greater than the refractive index n_{3B1} of the second glass layer 42C by 0.015 (n_{3E1}−n_{3B1}=0.015) for all wavelengths of the visible light. The refractive index n_{3C} of the third glass layer 43C was set to be a value that was greater than the refractive index n_{3B1} of the second glass layer 42C by 0.015 (n_{3C}−n_{3B1}=0.015) for all wavelengths of the visible light.

TABLE 6

| | | | | | | | | | |
|---|---|---|---|---|---|---|---|---|---|
| n_{3C} − n_{3B1} | 0.015 | 0.015 | 0.015 | 0.015 | 0.015 | 0.015 | 0.015 | 0.015 | 0.015 |
| n_{3E1} − n_{3B1} | 0.015 | 0.015 | 0.015 | 0.015 | 0.015 | 0.015 | 0.015 | 0.015 | 0.015 |
| t_{3C}/(t_{3E1} + t_{3B1} + | 0.02 | 0.02 | 0.02 | 0.02 | 0.02 | 0.02 | 0.02 | 0.02 | 0.02 |
| t_{3C} + t_{3B2} + t_{3E2}) | | | | | | | | | |
| t_{3E1}/(t_{3E1} + t_{3B1} + | 0.000 | 0.020 | 0.035 | 0.065 | 0.080 | 0.100 | 0.160 | 0.225 | 0.300 |
| t_{3C} + t_{3B2} + t_{3E2}) | | | | | | | | | |
| L(Ix) | 30664.6 | 30575.6 | 30501.5 | 30436.5 | 30423.7 | 30296.4 | 29850.0 | 29106.3 | 28624.9 |
| L/L0 | 1.00000 | 0.99710 | 0.99468 | 0.99256 | 0.99214 | 0.98799 | 0.97343 | 0.94918 | 0.93348 |

From Table 6 and FIG. 15, it can be seen that, if the ratio of the thickness of the first glass layer 41C with respect to the plate thickness of the glass plate 20C (t_{3E1}/(t_{3E1}+t_{3B1}+t_{3C}+t_{3B2}+t_{3E2})) is less than 0.08, the brightness almost does not decrease despite the presence of the five layer structure. The ratio of the thickness of the first glass layer 41C with respect to the plate thickness of the glass plate 20C (t_{3E1}/(t_{3E1}+t_{3B1}+t_{3C}+t_{3B2}+t_{3E2})) is preferably less than 0.06, and more preferably less than 0.04.

The embodiment of the glass plate for the light guide plate and the liquid crystal display are described above; however, the present invention is not limited to the above-described embodiment, and various modifications and improvements may be made within the scope of the gist of the present invention described in the claims.

For example, the liquid crystal display according to the above-described embodiment is a transmission type; however, the liquid crystal display may be a reflection type, and the glass plate 20 may be located in front of the liquid crystal panel 10. Light from the light source 30 enters the inner part from the edge surface of the glass plate 20; the light exits from the surface (the rear surface) of the glass plate 20 facing the liquid crystal panel 10; and the light uniformly illuminates the liquid crystal panel 10 from the front.

Further, in the above-described embodiment, the light source is the white LED; however, the light source may be a fluorescent tube. Furthermore, the type of the white LED is not particularly limited; and, for example, instead of the blue LED, an ultra violet LED whose wavelength is shorter than the wavelength of the blue LED may be used to cause a fluorophore to emit light. Furthermore, instead of the fluorophore-based white LED, a three-color LED based white LED may be used.

A chemical composition of the glass plate for the light guide plate may be diverse. For example, the glass compositions of the glass layer 22 that is the first glass layer of FIG. 5, the glass layer 24 that is the second glass layer of FIG. 5, the glass layer 25B that is the third glass layer of FIG. 11, the glass layer 42C that is the second glass layer of FIG. 14, and the glass layer 44C that is the fourth glass layer of FIG. 14 may be the following glass compositions.

As for the preferable compositions of the glass plates, there are the following three types (glass provided with a glass composition A, a glass composition B, and a glass composition C), as typical examples. However, the glass composition of the glass according to the present invention is not limited to the examples of the glass composition shown here.

A glass plate provided with the glass composition A preferably includes, in terms of mass percentage on a basis of oxide, 60% to 80% SiO₂; 0% to 7% Al₂O₃; 0% to 10% MgO; 0% to 20% CaO; 0% to 15% SrO; 0% to 15% BaO; 3% to 20% Na₂O; 0% to 10% K₂O; 5 ppm to 100 ppm Fe₂O₃. The refractive index of this glass with respect to d-ray of helium (the wavelength is 587.6 nm) at room temperature is from 1.45 to 1.60. As specific examples, there are examples 1 to 4, and example 15 of Table 7.

Further, a glass plate having the glass composition B preferably includes, in terms of mass percentage on a basis of oxide, 45% to 80% SiO₂; Al₂O₃ which is greater than 7% and less than or equal to 30%; 0% to 15% B₂O₃: 0% to 15% MgO; 0% to 6% CaO; 0% to 5% SrO; 0% to 5% BaO; 7% to 20% Na₂O; 0% to 10% K₂O; 0% to 10% ZrO₂; and 5 ppm to 100 ppm Fe₂O₃. The refractive index of this glass with respect to d-ray of helium (the wavelength is 587.6 nm) at room temperature is from 1.45 to 1.60. As specific examples, there are examples 5 to 11 of Table 7.

Further, a glass plate having the glass composition C preferably includes, in terms of mass percentage on a basis of oxide, 45% to 70% SiO₂; 10% to 30% Al₂O₃; 0% to 15% B₂O₃: 5% to 30% MgO, CaO, SrO, and BaO in total; greater than or equal to 0% and less than 3% Li₂O, Na₂O, and K₂O in total; and 5 ppm to 100 ppm Fe₂O₃. The refractive index of this glass with respect to d-ray of helium (the wavelength is 587.6 nm) at room temperature is from 1.45 to 1.60. As specific examples, there are examples 12 to 14 of Table 7.

For the glass plate according to the embodiment of the present invention including the above-described components, the composition ranges of the components of the glass composition are described below.

SiO₂ is a main component of the glass.

In order to maintain a weather resistance property and a devitrification property of the glass, the content of SiO₂ for the glass composition A in terms of mass percentage on a basis of oxide is preferably greater than or equal to 60%, and more preferably greater than or equal to 63%; the content of SiO₂ for the glass composition B in terms of mass percentage on a basis of oxide is preferably greater than or equal to 45%, and more preferably greater than or equal to 50%; and the content of SiO₂ for the glass composition C in terms of mass percentage on a basis of oxide is preferably greater than or equal to 45%, and more preferably greater than or equal to 50%.

However, in order to facilitate dissolution and to enhance foam quality, and in order to keep the content of ferrous (Fe²⁺) in the glass to be low, so that the optical property becomes favorable, the content of SiO₂ for the glass composition A in terms of mass percentage on a basis of oxide is preferably less than or equal to 80%, and more preferably less than or equal to 75%; the content of SiO₂ for the glass composition B in terms of mass percentage on a basis of oxide is preferably less than or equal to 80%, and more preferably less than or equal to 70%; and the content of SiO₂ for the glass composition C in terms of mass percentage on a basis of oxide is preferably less than or equal to 70%, and more preferably less than or equal to 65%.

For the glass compositions B and C, Al₂O₃ is an essential component to enhance the weather resistance property of the glass. In order to maintain a practically required weather resistance property of the glass according to the embodiment, the content of Al₂O₃ for the glass composition A is preferably greater than or equal to 1%, more preferably greater than or equal to 2%; the content of Al₂O₃ for the glass composition B is preferably greater than 7%, more preferably greater than or equal to 10%; and the content of Al₂O₃ for the glass composition C is preferably greater than or equal to 10%, more preferably greater than or equal to 13%.

However, in order to keep the content of ferrous (Fe²⁺) to be low, so that the optical property becomes favorable and foam quality becomes favorable, the content of Al₂O₃ for the glass composition A is preferably less than or equal to 7%, and more preferably less than or equal to 5%; the content of Al₂O₃ for the glass composition B is preferably less than or equal to 30%, and more preferably less than or equal to 23%; and the content of Al₂O₃ for the glass composition C is preferably less than or equal to 30%, and more preferably less than or equal to 20%.

Ba₂O₃ is a component for promoting melting of the glass materials, so that a mechanical property and the weather resistance property are enhanced; however, in order to prevent generation of a ream by volatilization, and to prevent occurrence of inconvenience, such as corrosion of a furnace wall, the content of Ba₂O₃ for the glass composition A is preferably less than or equal to 5%, and more preferably less than or equal to 3%; and the content of Ba₂O₃ for the glass compositions B and C is preferably less than or equal to 15%, and more preferably less than or equal to 12%.

The alkali metal oxides, such as Li₂O, Na₂O, and K₂O, are useful components for promoting melting of the glass materials, and for adjusting thermal expansion and viscosity of the glass materials.

Thus, the content of Na₂O for the glass composition A is preferably greater than or equal to 3%, and more preferably greater than or equal to 8%. The content of Na₂O for the glass composition B is preferably greater than or equal to 7%, and more preferably greater than or equal to 10%. However, in order to maintain the clarity during melting, and to maintain the foam quality of the glass to be produced, the content of Na₂O for the glass compositions A and B is preferably less than or equal to 20%, and more preferably less than or equal to 15%; and the content of Na₂O for the glass composition C is preferably less than or equal to 3%, and more preferably less than or equal to 1%.

Further, the content of K₂O for the glass compositions A and B is preferably less than or equal to 10%, and more preferably less than or equal to 7%; and the content of K₂O for the glass composition C is preferably less than or equal to 2%, and more preferably less than or equal to 1%.

Further, though Li₂O is an optional component, less than or equal to 2% Li₂O may be included in the glass compositions A, B, and C, so as to facilitate vitrification, to suppress the iron content contained as impurities derived from raw materials to be a low level, and to reduce the batch cost to be low.

Furthermore, in order to maintain the clarity during melting, and to maintain the foam quality of the glass to be produced, the total content of these alkali metal oxides (Li₂O+Na₂O+K₂O) for the glass compositions A and B is preferably from 5% to 20%, and more preferably from 8% to 15%; and the total content of these alkali metal oxides (Li₂O+Na₂O+K₂O) for the glass composition C is preferably from 0% to 2%, and more preferably from 0% to 1%.

The alkali earth metal oxides, such as MgO, CaO, SrO, and BaO, are useful components for promoting melting of the glass materials, and for adjusting thermal expansion, viscosity, and so forth of the glass materials.

MgO affects to promote melting by lowering viscosity during melting of the glass. In addition, MgO affects to reduce a specific gravity, and to prevent the glass plate from being scratched, so that MgO may be included in the glass compositions A, B, and C. Furthermore, the content of MgO for the glass composition A is preferably less than or equal to 10%, and more preferably less than or equal to 8%; the content of MgO for the glass composition B is preferably less than or equal to 15%, and more preferably less than or equal to 12%; and the content of MgO for the glass composition C is preferably less than or equal to 10%, and more preferably less than or equal to 5%, so that the thermal expansion coefficient of the glass can be small and the devitrification property can be favorable.

Since CaO is a component that promotes melting of the glass materials, and that adjusts viscosity, thermal expansion, and so forth of the glass materials, CaO may be included in the glass compositions A, B, and C. In order to obtain the above-described effects, the content of CaO for the glass composition A is preferably greater than or equal to 3%; and more preferably greater than or equal to 5%. Additionally, in order to improve the devitrification, the content of CaO for the glass composition A is preferably less than or equal to 20%, and more preferably less than or equal to 10%; and the content of CaO for the glass composition B is preferably less than or equal to 6%, and more preferably less than or equal to 4%.

SrO affects to increase the thermal expansion coefficient, and to lower high-temperature viscosity of the glass. In order to obtain such effects, SrO may be included in the glass compositions A, B, and C. However, in order to suppress the thermal expansion coefficient to be small, the content of SrO for the glass compositions A and C is preferably less than or equal to 15%, and more preferably less than or equal to 10%; and the content of SrO for the glass composition B is preferably less than or equal to 5%, and more preferably less than or equal to 3%.

Similar to SrO, BaO affects to increase the thermal expansion coefficient, and to lower high-temperature viscosity of the glass. In order to obtain the above-described effects, BaO may be included in the glass compositions A, B, and C. However, in order to suppress the thermal expansion coefficient to be small, the content of BaO for the glass compositions A and C is preferably less than or equal to 15%, and more preferably less than or equal to 10%; and the content of BaO for the glass composition B is preferably less than or equal to 5%, and more preferably less than or equal to 3%.

Furthermore, in order to suppress the thermal expansion coefficient to be small, to make the devitrification property favorable, and to maintain robustness, the total content of these alkali earth metal oxides (MgO+CaO+SrO+BaO) for the glass composition A is preferably from 10% to 30%, and more preferably from 13% to 27%; the total content of these alkali earth metal oxides (MgO+CaO+SrO+BaO) for the glass composition B is preferably from 1% to 15%, and more preferably from 3% to 10%; and the total content of these alkali earth metal oxides (MgO+CaO+SrO+BaO) for the glass composition C is preferably from 5% to 30%, and more preferably from 10% to 20%.

In the glass composition of the glass of the glass plate according to the embodiment of the present invention, in order to enhance the heat resistance and surface hardness of the glass, each of the glass compositions A, B, and C may include less than or equal to 10% ZrO₂, preferably less than or equal to 5% ZrO₂, as an optional component. However, if the content of ZrO₂ exceeds 10%, the glass tends to devitrify, so that it is not preferable.

In the glass composition of the glass of the glass plate according to the embodiment of the present invention, in order to enhance the melting property of the glass, each of the glass compositions A, B, and C may include 5 ppm to 100 ppm Fe₂O₃. Here, the content of Fe₂O₃ refers to the whole quantity of iron oxide in terms of Fe₂O₃. The whole quantity of iron oxide is preferably from 5 ppm by mass to 50 ppm by mass, and more preferably from 5 ppm by mass to 30 ppm by mass. If the above-described whole quantity of iron oxide is less than 5 ppm, the infrared light absorption property of the glass is extremely deteriorated, it becomes difficult to enhance the melting property of the glass, and a large cost is required to purify the raw materials, so that it is not preferable that the whole quantity of iron oxide be less than 5 ppm. Furthermore, if the whole quantity of iron oxide exceeds 100 ppm, coloration of the glass becomes significant, and the visible light transmittance is reduced, so that it is not preferable that the whole quantity of iron oxide exceeds 100 ppm.

Further, the glass of the glass plate according to the embodiment of the present invention may include SO₃, as a clarifying agent. In this case, the content of SO₃, in terms of mass percentage, is preferably greater than 0% and less than or equal to 0.5%. The content of SO₃ is more preferably less than or equal to 0.4%, further more preferably less than or equal to 0.3%, and particularly preferably less than or equal to 0.25%.

Further, the glass of the glass plate according to the embodiment of the present invention may include one or more of Sb₂O₃, SnO₂, and As₂O₃, as an oxidizing agent and a clarifying agent. In this case, the content of Sb₂O₃, SnO₂, and As₂O₃, in terms of mass percentage, is preferably from 0% to 0.5%. The content of Sb₂O₃, SnO₂, and As₂O₃ is more preferably less than or equal to 0.2%, and further more preferably less than or equal to 0.1%; and it is further more preferable that Sb₂O₃, SnO₂, and As₂O₃ be substantially not included.

However, Sb₂O₃, SnO₂, and As₂O₃ affect as the oxidizing agent of the glass, so that Sb₂O₃, SnO₂, and As₂O₃ may be added within the above-described range so as to adjust the amount of Fe²⁺ of the glass. However, As₂O₃ may not be positively included due to environmental concern.

Furthermore, the glass of the glass plate according to the embodiment of the present invention may include NiO. When NiO is included, NiO functions as a coloring component, so that the content of NiO is preferably less than or equal to 100 ppm with respect to the total amount of the glass composition described above. In particular, from the viewpoint that NiO does not cause the internal transmittance of the glass plate at a wavelength from 400 nm to 700 nm to be lowered, the content of NiO is preferably less than or equal to 1.0 ppm, and more preferably less than or equal to 0.5 ppm.

Furthermore, the glass of the glass plate according to the embodiment of the present invention may include Cr₂O₃. When Cr₂O₃ is included, Cr₂O₃ functions as a coloring component, so that the content of Cr₂O₃ is preferably less than or equal to 10 ppm with respect to the total amount of the glass composition described above. In particular, from the viewpoint that Cr₂O₃ does not cause the internal transmittance of the glass plate at a wavelength from 400 nm to 700 nm to be lowered, the content of Cr₂O₃ is preferably less than or equal to 1.0 ppm, and more preferably less than or equal to 0.5 ppm.

The glass of the glass plate according to the embodiment of the present invention may include MnO₂. When MnO₂ is included, MnO₂ functions as a component that absorbs visible light, so that the content of MnO₂ is preferably less than or equal to 50 ppm with respect to the total amount of the glass composition described above. In particular, from the viewpoint that MnO₂ does not cause the internal transmittance of the glass plate at a wavelength from 400 nm to 700 nm to be lowered, the content of MnO₂ is preferably less than or equal to 10 ppm.

The glass of the glass plate according to the embodiment of the present invention may include TiO₂. When TiO₂ is included, TiO₂ functions as a component that absorbs visible light, so that the content of TiO₂ is preferably less than or equal to 1000 ppm with respect to the total amount of the glass composition described above. In particular, from the viewpoint that TiO₂ does not cause the internal transmittance of the glass plate at a wavelength from 400 nm to 700 nm to be lowered, the content of TiO₂ is preferably less than or equal to 500 ppm, and more preferably less than or equal to 100 ppm.

The glass of the glass plate according to the embodiment of the present invention may include CeO₂. CeO₂ affects to decelerate the Redox (the reduction-oxidation reaction) of iron, and CeO₂ can reduce the absorption of the glass at a wavelength from 400 nm to 700 nm. However, if a large amount of CeO₂ is included, CeO₂ also functions as a component to absorb visible light, and CeO₂ may lower the Redox of iron to be less than 3%, so that it is not preferable that the large amount of CeO₂ be included. Thus, the content of CeO₂ is preferably less than or equal to 1000 ppm with respect to the total amount of the glass composition described above. Furthermore, the content of CeO₂ is more preferably less than or equal to 500 ppm, further more preferably less than or equal to 400 ppm, particularly preferably less than or equal to 300 ppm, and most preferably less than or equal to 250 ppm.

The glass of the glass plate according to the embodiment of the present invention may include at least one component selected from a group formed of CoO, V₂O₅, and CuO. When CoO, V₂O₅, and CuO are included, CoO, V₂O₅, and CuO function as components for absorbing visible light, so that the content of CoO, V₂O₅, and CuO is preferably less than or equal to 10 ppm with respect to the total amount of the glass composition described above. In particular, it is preferable that CoO, V₂O₅, and CuO be substantially not included in the glass, so that the internal transmittance of the glass plate for a wavelength from 400 nm to 700 nm is not lowered.

TABLE 7

| | ex. 1 | ex. 2 | ex. 3 | ex. 4 | ex. 5 | ex. 6 | ex. 7 | ex. 8 | ex. 9 | ex. 10 | ex. 11 | ex. 12 | ex. 13 | ex. 14 | ex. 15 |
|---|---|---|---|---|---|---|---|---|---|---|---|---|---|---|---|
| SiO₂ (mass %) | 72.0 | 71.8 | 68.5 | 57.5 | 52.0 | 61.0 | 65.0 | 65.0 | 58.5 | 56.0 | 62.0 | 60.0 | 60.0 | 62.0 | 69.8 |
| B₂O₃ (mass %) | — | — | — | — | — | — | — | — | 5.0 | 2.0 | — | 8.0 | 10.0 | 11.0 | — |
| Al₂O₃ (mass | 1.5 | 1.0 | 5.0 | 7.0 | 12.0 | 13.0 | 16.0 | 14.0 | 22.0 | 13.0 | 19.0 | 17.0 | 15.0 | 17.0 | 3.0 |
| %) | | | | | | | | | | | | | | | |
| Li₂O (mass %) | — | — | — | — | — | — | — | — | — | — | — | — | — | — | — |
| Na₂O (mass %) | 13.5 | 13.6 | 14.5 | 4.5 | 6.0 | 12.0 | 14.0 | 13.7 | 13.4 | 15.0 | 14.0 | — | — | — | 11.0 |
| K₂O (mass %) | — | — | 0.5 | 6.0 | 4.0 | 6.0 | — | 2.0 | — | 5.0 | 1.7 | — | — | — | — |
| MgO (mass %) | 4.0 | 4.0 | 4.0 | 2.0 | 0.2 | 7.0 | 5.0 | 4.5 | 1.0 | 2.0 | 3.0 | 3.0 | 0.1 | 1.0 | — |
| CaO (mass %) | 8.5 | 9.0 | 7.0 | 5.0 | 5.0 | — | — | 0.5 | — | 2.0 | — | 4.0 | 5.4 | 7.5 | 8.0 |
| SrO (mass %) | — | — | — | 7.0 | 12.1 | — | — | — | — | — | — | 7.7 | 5.7 | 0.9 | 4.0 |
| BaO (mass %) | — | — | — | 8.0 | 3.5 | — | — | — | — | — | — | — | 3.5 | 0.5 | 4.0 |
| ZrO₂ (mass %) | — | — | — | 3.0 | 5.0 | 1.0 | — | 0.1 | — | 4.5 | — | — | — | — | — |
| TiO₂ (mass %) | 0.1 | — | 0.1 | — | 0.1 | — | — | — | — | — | — | — | — | — | — |
| SnO₂ (mass %) | — | — | — | — | — | — | — | — | — | 0.3 | 0.2 | — | 0.2 | 0.1 | — |
| SO₃ (mass %) | 0.4 | 0.4 | 0.4 | — | 0.1 | — | — | 0.2 | 0.1 | — | — | — | 0.1 | — | 0.2 |
| Sb₂O₃ (mass | — | 0.2 | — | — | — | — | — | — | — | 0.1 | — | 0.2 | — | — | — |
| %) | | | | | | | | | | | | | | | |
| CI (mass %) | — | — | — | — | — | — | — | — | — | 0.1 | 0.1 | 0.1 | — | — | — |
| Fe₂O₃ (mass | 50 | 50 | 50 | 50 | 50 | 50 | 50 | 50 | 50 | 50 | 50 | 50 | 50 | 50 | 28 |
| ppm) | | | | | | | | | | | | | | | |
| CeO₂ (mass | — | — | — | — | — | — | — | — | — | — | — | — | — | — | 200 |
| Ppm) | | | | | | | | | | | | | | | |
| n_{d} | 1.52 | 1.52 | 1.52 | 1.55 | 1.55 | 1.51 | 1.50 | 1.51 | 1.50 | 1.51 | 1.50 | 1.52 | 1.52 | 1.51 | 1.52 |

1. A glass plate for a light guide plate comprising:
a first glass layer;
a second glass layer facing the first glass layer; and
a third glass layer, the third glass layer being an intermediate glass layer formed between the first glass layer and the second glass layer,
wherein the glass plate is provided with a three layer structure in a plate thickness direction of the glass plate, and
wherein the glass plate satisfies
t_{1C}/(t_{1B1}+t_{1B2}+t_{1C})<0.03 (1);
n_{1C}>n_{1B1} (2); and
n_{1C}>n_{1B2} (3),
where t_{1B1} is a thickness of the first glass layer, t_{1B2} is a thickness of the second glass layer, t_{1C} is a thickness of the third glass layer, n_{1B1} is a refractive index of the first glass layer, n_{1B2} is a refractive index of the second glass layer, and n_{1C} is a refractive index of the third glass layer.

2. The glass plate for the light guide plate according to claim 1, wherein each of the first glass layer and the second glass layer includes, in teens of mass percentage on a basis of oxide, 60% to 80% SiO₂; 0% to 7% Al₂O₃; 0% to 10% MgO; 0% to 20% CaO; 0% to 15% SrO; 0% to 15% BaO; 3% to 20% Na₂O; 0% to 10% K₂O; and 5 ppm to 100 ppm Fe₂O₃.

3. The glass plate for the light guide plate according to claim 1, wherein each of the first glass layer and the second glass layer includes, in terms of mass percentage on a basis of oxide, 45% to 80% SiO₂; greater than 7% and less than or equal to 30% Al₂O₃; 0% to 15% B₂O₃: 0% to 15% MgO; 0% to 6% CaO; 0% to 5% SrO; 0% to 5% BaO; 7% to 20% Na₂O; 0% to 10% K₂O; 0% to 10% ZrO₂; and 5 ppm to 100 ppm Fe₂O₃.

4. The glass plate for the light guide plate according to claim 1, wherein each of the first glass layer and the second glass layer includes, in terms of mass percentage on a basis of oxide, 45% to 70% SiO₂; 10% to 30% Al₂O₃; 0% to 15% B₂O₃: 5% to 30% MgO, CaO, SrO, and BaO in total; greater than or equal to 0% and less than 3% Li₂O, Na₂O, and K₂O in total; and 5 ppm to 100 ppm Fe₂O₃.

5. A glass plate for a light guide plate comprising:
a first glass layer;
a second glass layer facing the first glass layer; and
a third glass layer, the third glass layer being an intermediate glass layer formed between the first glass layer and the second glass layer,
wherein the glass plate is provided with a three layer structure in a plate thickness direction of the glass plate, and
wherein the glass plate satisfies
t_{2E1}/(t_{2E1}+t_{2E2}+t_{2B})<0.08 (4);
t_{2E2}/(t_{2E1}+t_{2E2}+t_{2B})<0.08 (5);
n_{2B}<n_{2E1} (6); and
n_{2B}<n_{2E2} (7),
where t_{2E1} is a thickness of the first glass layer, t_{2E2} is a thickness of the second glass layer, t_{2B} is a thickness of the third glass layer, n_{2E1} is a refractive index of the first glass layer, n_{2E2} is a refractive index of the second glass layer, and n_{2B} is a refractive index of the third glass layer.

6. The glass plate for the light guide plate according to claim 5, wherein the third glass layer includes, in terms of mass percentage on a basis of oxide, 60% to 80% SiO₂; 0% to 7% Al₂O₃; 0% to 10% MgO; 0% to 20% CaO; 0% to 15% SrO; 0% to 15% BaO; 3% to 20% Na₂O; 0% to 10% K₂O; and 5 ppm to 100 ppm Fe₂O₃.

7. The glass plate for the light guide plate according to claim 5, wherein the third glass layer includes, in terms of mass percentage on a basis of oxide, 45% to 80% SiO₂; greater than 7% and less than or equal to 30% Al₂O₃; 0% to 15% B₂O₃: 0% to 15% MgO; 0% to 6% CaO; 0% to 5% SrO; 0% to 5% BaO; 7% to 20% Na₂O; 0% to 10% K₂O; 0% to 10% ZrO₂; and 5 ppm to 100 ppm Fe₂O₃.

8. The glass plate for the light guide plate according to claim 5, wherein the third glass layer includes, in terms of mass percentage on a basis of oxide, 45% to 70% SiO₂; 10% to 30% Al₂O₃; 0% to 15% B₂O₃: 5% to 30% MgO, CaO, SrO, and BaO in total; greater than or equal to 0% and less than 3% Li₂O, Na₂O, and K₂O in total; and 5 ppm to 100 ppm Fe₂O₃.

9. A glass plate for a light guide plate comprising:
a first glass layer;
a second glass layer;
a third glass layer;
a fourth glass layer; and
a fifth glass layer,
wherein the glass plate is provided with a five layer structure in which the first glass layer, the second glass layer, the third glass layer, the fourth glass layer, and the fifth glass layer are laminated in this order in a plate thickness direction of the glass plate, and
wherein the glass plate satisfies
t_{3C}/(t_{3E1}+t_{3B1}+t_{3C}+t_{3B2}+t_{3E2})<0.03 (8);
t_{3E1}/(t_{3E1}+t_{3B1}+t_{3C}+t_{3B2}+t_{3E2})<0.08 (9):
t_{3E2}/(t_{3E1}+t_{3B1}+t_{3C}+t_{3B2}+t_{3E2})<0.08 (10);
n_{3C}>n_{3B1} (11);
n_{3C}>n_{3B2} (12);
n_{3E1}>n_{3B1} (13);
n_{3E1}>n_{3B2} (14);
n_{3E2}>n_{3B1} (15); and
n_{3E2}>n_{3B2} (16),
where t_{3E1} is a thickness of the first glass layer, t_{3B1} is a thickness of the second glass layer, t_{3C} is a thickness of the third glass layer, t_{3B2} is a thickness of the fourth glass layer, t_{3E2} is a thickness of the fifth glass layer, n_{3E1} is a refractive index of the first glass layer, n_{3B1} is a refractive index of the second glass layer, n_{3C} is a refractive index of the third glass layer, n_{3B2} is a refractive index of the fourth glass layer, n_{3E2} is a refractive index of the fifth glass layer.

10. The glass plate for the light guide plate according to claim 9, wherein each of the second glass layer and the fourth glass layer includes, in terms of mass percentage on a basis of oxide, 60% to 80% SiO₂; 0% to 7% Al₂O₃; 0% to 10% MgO; 0% to 20% CaO; 0% to 15% SrO; 0% to 15% BaO; 3% to 20% Na₂O; 0% to 10% K₂O; and 5 ppm to 100 ppm Fe₂O₃.

11. The glass plate for the light guide plate according to claim 9, wherein each of the second glass layer and the fourth glass layer includes, in terms of mass percentage on a basis of oxide, 45% to 80% SiO₂; greater than 7% and less than or equal to 30% Al₂O₃; 0% to 15% B₂O₃: 0% to 15% MgO; 0% to 6% CaO; 0% to 5% SrO; 0% to 5% BaO; 7% to 20% Na₂O; 0% to 10% K₂O; 0% to 10% ZrO₂; and 5 ppm to 100 ppm Fe₂O₃.

12. The glass plate for the light guide plate according to claim 9, wherein each of the second glass layer and the fourth glass layer includes, in terms of mass percentage on a basis of oxide, 45% to 70% SiO₂; 10% to 30% Al₂O₃; 0% to 15% B₂O₃: 5% to 30% MgO, CaO, SrO, and BaO in total; greater than or equal to 0% and less than 3% Li₂O, Na₂O, and K₂O in total; and 5 ppm to 100 ppm Fe₂O₃.
